(19) United States
(12) Patent Application Publication
(10) Pub. No.: US 2025/0296004 A1
(43) Pub. Date: Sep. 25, 2025

(54) RACING AND FLIGHT SIMULATION SEAT ASSEMBLY WITH DETACHABLE SEAT ELEMENT

(71) Applicant: HOME RACER LLC, Boynton Beach, FL (US)

(72) Inventor: Dimitar Pavlov, Boynton Beach, FL (US)

(73) Assignee: HOME RACER LLC, Boynton Beach, FL (US)

(21) Appl. No.: 18/862,386

(22) PCT Filed: Jul. 28, 2023
(86) PCT No.: PCT/US23/29014

§ 371 Date: Nov. 1, 2024

Related U.S. Application Data
(60) Provisional application No. 63/392,970, filed on Jul. 28, 2022.

(51) Int. Cl. A63F 13/98; A47C 7/02; A47C 15/00; A63F 13/803

(52) U.S. Cl. CPC A63F 13/98; A47C 7/0213; A47C 15/004; A63F 13/803

(57) ABSTRACT

A racing and flight simulation seat assembly with detachable seat element that includes a seat cushion a structural frame element operably configured to couple with a gaming cockpit framework frame assembly, formed with a deformably resilient material, a seat thickness separating an upper surface and a bottom surface of the seat cushion, with a rear surface interposed between the upper and bottom surfaces of the seat cushion, and with a front surface interposed between the upper and bottom surfaces of the seat cushion, opposing the rear surface of the seat cushion, and defining a cutout channel spanning the seat thickness and spanning rearwardly toward the rear surface of the seat cushion, a seat element selectively removably coupled to the seat cushion with at least one fastener, formed with a deformably resilient material, and disposed within the cutout channel, and with a back cushion coupled to the seat cushion.

### FIELD OF THE INVENTION

The present invention relates generally to racing and flight simulation seat assemblies, and more particularly, to a gaming chair assembly with a detachable seat element.

### BACKGROUND OF THE INVENTION

Numerous industries such as, for example, the video game industry, and various technical training programs such as airline and commercial pilot flight training programs, require the use of seat assemblies configured in such a way as to give users the ability to maneuver controls, manipulate handles, and interact with computerized screens or simulators. In the video gaming or simulation training industry, simulation seat assemblies have amassed great popularity and fame as users seek to maintain full immersion and comfort while gaming or practicing in a simulation environment for hours without having to sacrifice the maneuverability and flexibility of movement needed to adequately perform and maintain proper framework geometry and arm reach for building positive cognitive memory, muscle memory, and accurate task procedure learning.

As such, a growing need in various industries has arisen for gaming chair simulation seat assemblies that provide natural comfort, maneuverability, high level of realism, precise fidelity, and adjustability. This need is exacerbated when utilizing specialty controls, particularly those conventionally operable by the seat of the user. Existing prior art, however, does not provide solutions for such needs with respect, specifically, to central foam seat slanted cutouts that can be selectively detached to provide sufficient space for a flight simulation center stick mount or helicopter cyclic where the stick or cyclic may be brought closer to the user without protruding into the seat foam or physically obstructing the hand of the user while used in all and full directional ranges of motion. Other known art also fails to simultaneously provide adequate impact protection to the user while also enabling versatility with respect to the use of utilizing controls, particularly flight controls.

Therefore, a need exists to overcome the problems with the prior art as discussed above.

### SUMMARY OF THE INVENTION

The invention provides a gaming chair assembly with detachable seat element that overcomes the hereinafore-mentioned disadvantages of the heretofore-known devices and methods of this general type.

With the foregoing and other objects in view, there is provided, in accordance with the invention, a racing and flight simulation seat assembly with detachable seat element is disclosed that includes a seat cushion with at least one substantially rigid structural frame element operably configured to couple with a racing and flight simulation seat assembly, formed with a deformably resilient material, with an upper surface configured to support a user, a bottom surface opposing the upper surface of the seat cushion, a seat thickness separating the upper and bottom surfaces of the seat cushion, with a rear surface interposed between the upper and bottom surfaces of the seat cushion, and with a front surface interposed between the upper and bottom surfaces of the seat cushion, opposing the rear surface of the seat cushion, and defining a cutout channel spanning the seat thickness and spanning rearwardly toward the rear surface of the seat cushion. The racing and flight simulation seat assembly also includes a seat element selectively removably coupled to the seat cushion with at least one fastener, formed with a deformably resilient material, and disposed within the cutout channel and a back cushion coupled to the seat cushion in an erect orientation relative to the upper surface of the seat cushion.

In a further embodiment, the present invention also includes the seat element, the seat cushion, and back cushion are formed with a foam body.

In an additional embodiment, the present invention also includes the front surface defining the cutout channel having two cutout sidewalls opposing one another.

In yet another embodiment, the present invention also includes the front surface defining the cutout channel having a rear cutout wall interposed between the two cutout sidewalls, with a slanted cut to provide full directional motion without interference.

In a further embodiment, the present invention also includes the seat element selectively removably coupled to the rear cutout wall with a hook-and-loop fastener coupled to both the seat element and the rear cutout wall. The hook-and-loop fastener may substantially span the seat thickness.

In an exemplary embodiment, the present invention also includes the seat element substantially spanning the seat thickness.

In yet another embodiment, the present invention also includes the seat element of a shape and a size conforming to a shape and a size of the cutout channel.

In a further embodiment, the present invention also includes the seat element substantially spanning the seat thickness.

In an additional embodiment, the present invention also includes the cutout channel formed in a U-shape or V-shape due to slanted cut out.

In yet another embodiment, the present invention also includes the seat element having a foam seat element body and a cover encapsulating the foam seat element body, wherein the cover is operably configured to be selectively opened and closed with at least one fastener. In one embodiment, the foam seat element body is of a monolithic configuration and formed without any structural frame or support elements. Further, the cutout channel may be centrally defined on the seat cushion.

Also in accordance with the present invention, a racing and flight simulation seat assembly is disclosed that includes a seat cushion with at least one structural frame element operably configured to couple with a cockpit framework frame assembly, with an upper surface configured to support a user, formed with a deformably resilient material, with a bottom surface opposing the upper surface of the seat cushion, a seat thickness separating the upper and bottom surfaces of the seat cushion, with a rear surface interposed between the upper and bottom surfaces of the seat cushion, and with a front surface interposed between the upper and bottom surfaces of the seat cushion, opposing the rear surface of the seat cushion, and defining a cutout channel centrally defined on the seat cushion, spanning the seat thickness, and spanning rearwardly toward the rear surface of the seat cushion. The assembly also includes a seat element disposed within the cutout channel, a fastening means configured to selectively removably couple the seat element with the seat cushion, and a back cushion coupled to the seat cushion in an erect orientation relative to the upper surface of the seat cushion.

In an additional embodiment, the present invention also includes the seat element formed with a deformably resilient material and the seat element body is formed without any structural frame or support elements.

Although the invention is illustrated and described herein as embodied in a gaming chair assembly with detachable seat element, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “bottom”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the monitor framing assembly, spanning from one side to another, wherein traverse may mean a direction spanning from the lower end to the upper end of the monitor framing assembly. As used herein, the term “wall” is intended broadly to encompass continuous structures, as well as separate structures that are coupled together so as to form a substantially continuous external surface.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIGS. 1-6 depict perspective, elevational front, elevational side, elevational rear, top plan, and bottom plan views, respectively, of a gaming chair assembly with detachable seat element in accordance with an exemplary embodiment of the present invention;

FIGS. 7-13 depict elevational front, front perspective, elevational side, rear perspective, front perspective, overhead, and underneath photos, respectively, of a gaming chair assembly with detachable seat element in accordance with an exemplary embodiment of the present invention; and

FIG. 14 depicts a fragmentary cross-sectional view of the seat cushion and seat element along section line 14-14 depicted in FIG. 1 in accordance with an exemplary embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

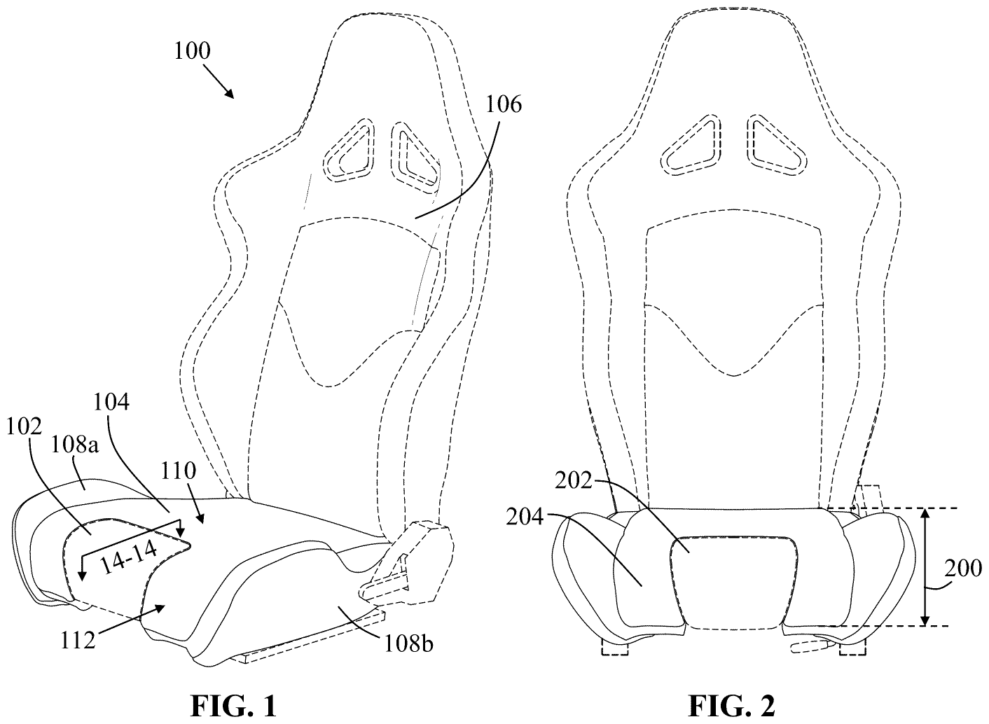

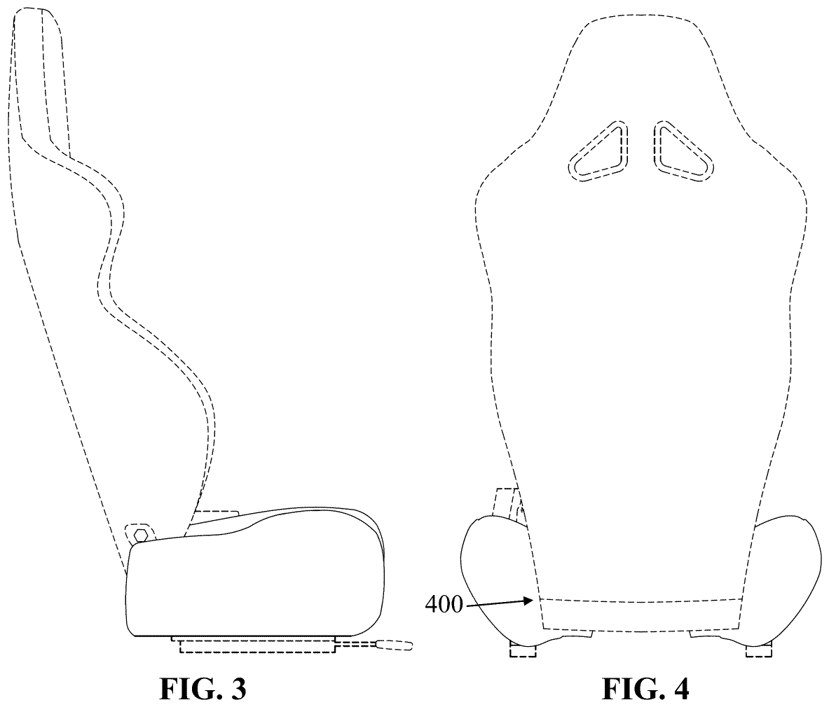

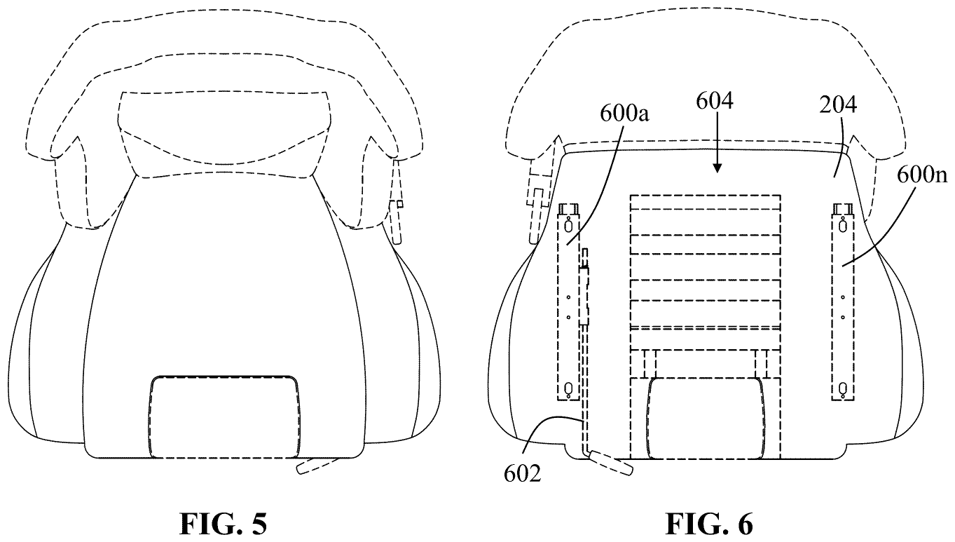

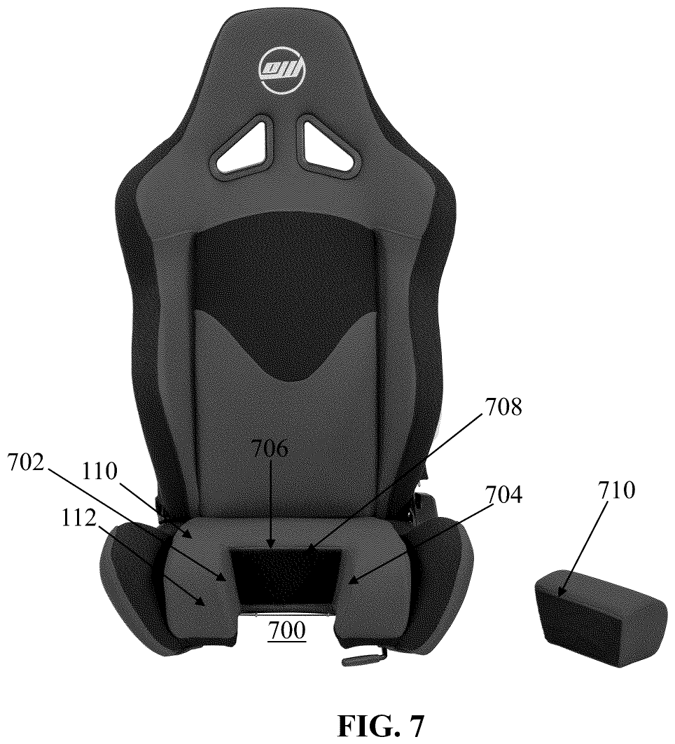

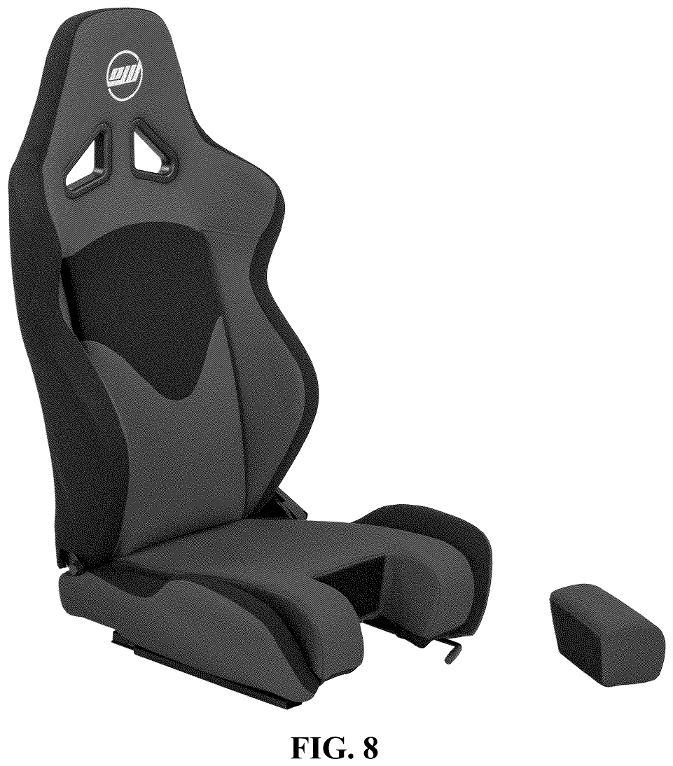

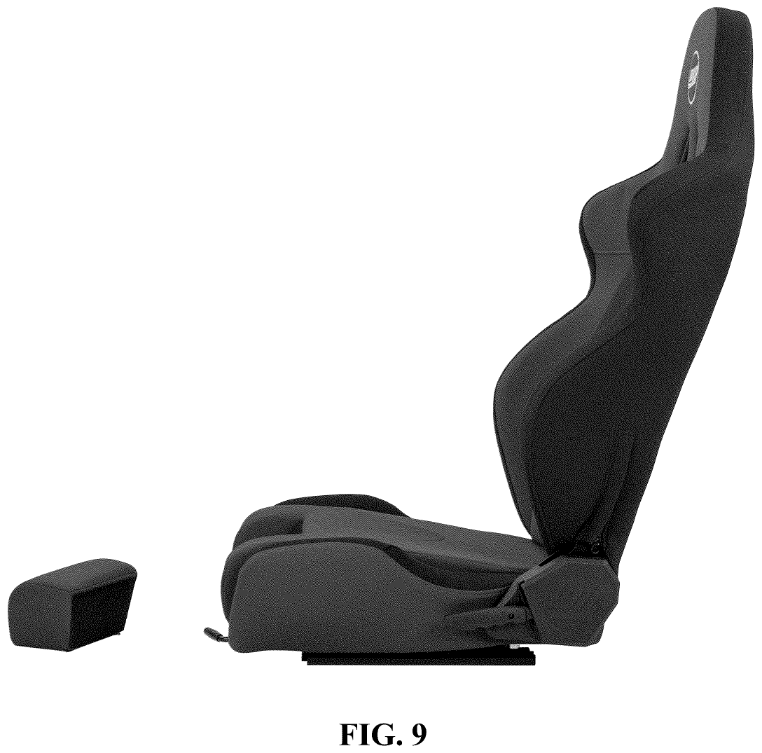

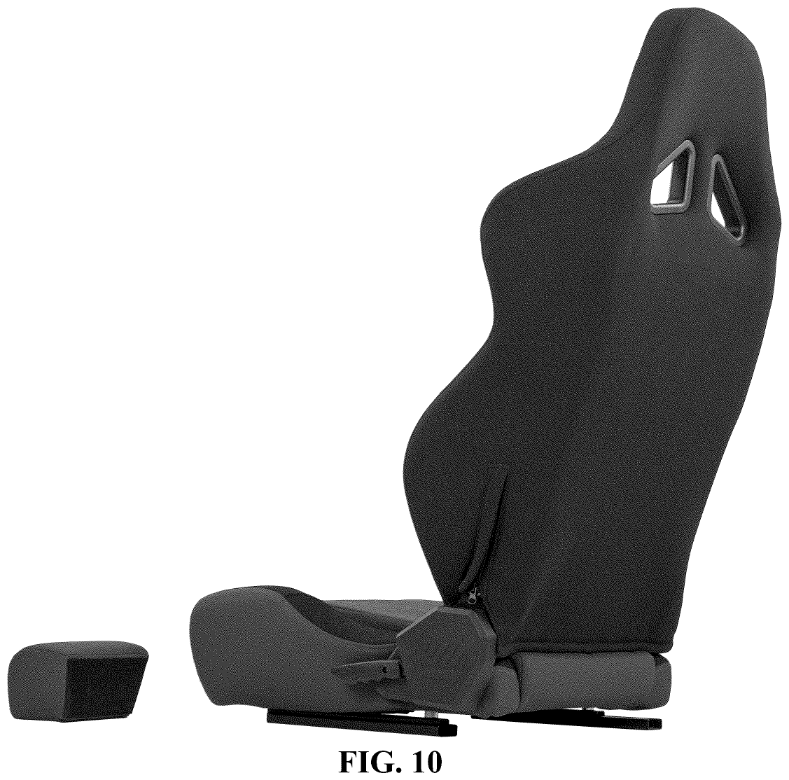

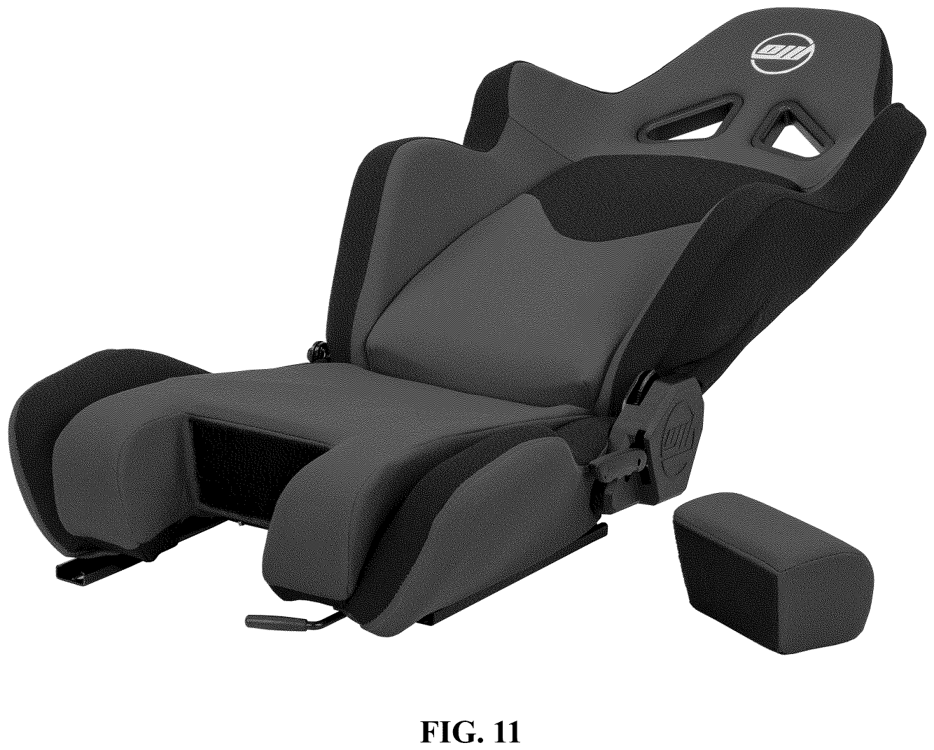

Referring now to FIGS. 1-6, one embodiment of a racing and flight simulation seat assembly with detachable seat element is shown in various views. FIGS. 7-13 depict photos of a racing and flight simulation seat assembly with detachable seat element also in accordance with the present invention and for clarity in disclosure of the invention. FIGS. 1-13 show several advantageous features of the present invention, but, as will be described below, the invention can be provided in several shapes, sizes, combinations of features and components, and varying numbers and functions of the components. The figures may also depict exemplary and approximate dimensions for the components utilized in the racing and flight simulation seat assembly.

More specifically, with reference to FIG. 1 and FIG. 6 as an example, the racing and flight simulation seat assembly, generally represented with numeral 100, beneficially includes a selectively detachable and attachable seat element 102 forming part of the seat cushion 104, wherein the seat cushion 104 is coupled to the back cushion 106. The assembly 100, namely the bottom surface 604 of the seat cushion 104, may also include one or a plurality of frame elements, e.g., frame elements 600a-n, wherein “n” represents any number greater than one.

The frame elements 600a-n are beneficially configured to selectively couple and translate (e.g., linearly move) the chair assembly 100 to other structural components, e.g., tubular frame elements, of a gaming and flight simulation assembly. The frame elements 600a-n may be of a substantially rigid and metallic material, e.g., stainless steel, aluminum, etc., but may be of another substantially rigid material. The frame elements 600a-n may include one or more apertures or fasteners (as shown) that enable the assembly 100 to couple with a cockpit framing frame assembly, or gaming frame assembly, such as the frame assembly depicted in Applicant's prior publications, including Pavlov, U.S. Patent Application Publication No. 20220408931A1 (wherein said reference is incorporated herein by reference). The gaming frame assembly may include frame elements configured to support and potentially move electronic and structural components, such as joysticks, keyboards, monitors, etc.

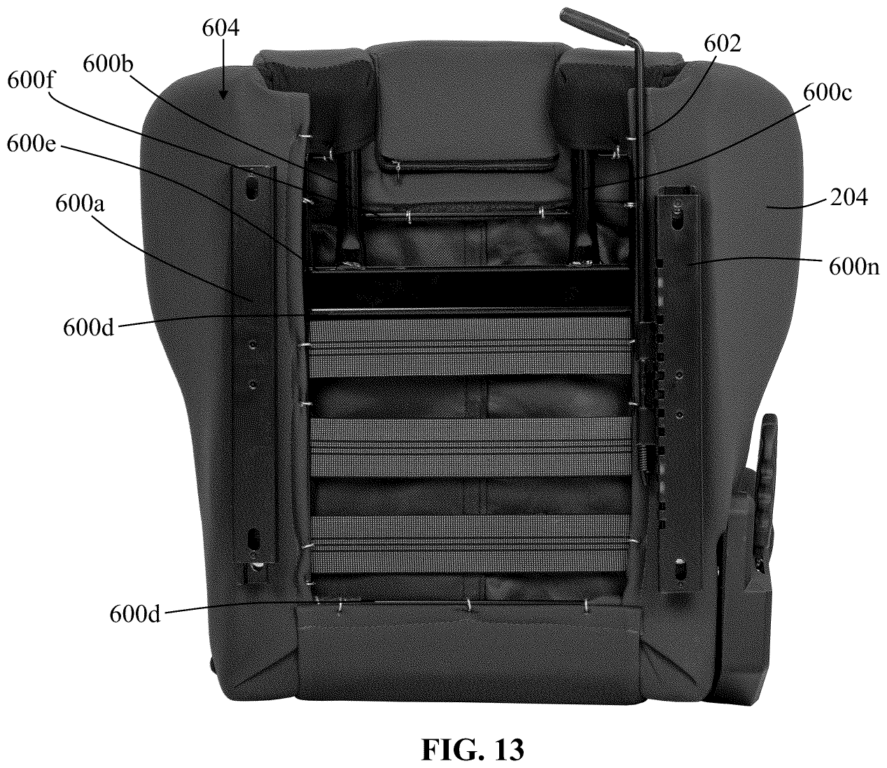

One or more of the frame elements 600a-n may be coupled with a lever 602 to enable translation of the seat assembly 100 relative to the framing of the gaming assembly. The frame elements 600a-n can also be seen in FIG. 13 and may include longitudinally oriented frame elements 600a, 600b, 600c, 600n and horizontally oriented frame elements 600d, 600e, 600f each disposed within or formed as part of the seat cushion 104. Preferably, there are no structural frame elements disposed within or forming part of the seat element 102, thereby enabling quick and effective attachment of the seat element 102 because of the reduced weight. Said another way, the seat element 102 is formed without any structural frame or support elements and is preferably formed solely of the deformably resilient material, e.g., a foam body 1400 and a selectively removable cover 1402. This enables the seat element 102 to be lightweight and easily removable, yet effective to cushion the user from impact when attached to the seat cushion 104.

The frame elements 600a-n may form a truss configuration or lattice configuration that is configured to support the weight of a user, which is particularly important in the environments of simulation racing, flight simulations, and intense gaming or training, where significant forces are experienced by the seat cushion 104. The frame elements 600a-n may also be described as being made with or of a substantially rigid and durable material, such as stainless steel that may be powder coated. The seat cushion 102, or cushion member, is operably configured for direct physical contact with the user and is, therefore, designed for optimal comfort during use in addition to structural stability. As seen in the figures, the seat cushion 104 may also be formed with multiple cushion members that may be selectively coupled together and, in some embodiments, may be monolithic. A cover (e.g., cover 204) may cover and/or encapsulate the foam material for the seat cushion 104 and may be of a soft and durable material, e.g., polyester fabric, neoprene, canvas, leather, etc. As best seen in FIG. 6 and FIG. 13, the cover 204 may also include elastic straps configured to retain the cover 204 on the seat cushion 104. The seat cushion 104 may also be formed with side thigh portions 108a-b that may project vertically over the upper surface 110 of the seat cushion 104 where the user is primarily supported.

With reference to FIG. 1, FIG. 6, and FIG. 7, the seat element 102 is preferably centrally disposed on the seat cushion 104, wherein a cutout channel 700 is defined. Said another way, the cutout channel 700 is centrally defined on the seat cushion 104. The term “centrally” is defined by an axis spanning through the geometric center of the seat cushion 104 or the center of mass of the seat cushion 104. The seat cushion 104 and seat element 102 may be formed with a deformably resilient material that provides comfort to the user. In preferred embodiments, at least the seat cushion 104 is formed with the deformably resilient material, as that is where the principal weight of the user is supported. In one embodiment, the deformably resilient material is a thick cold cured foam, beneficially providing maximum comfort for long hours of gaming or simulation training by the user. The assembly 100 also includes a back cushion 106 coupled to the seat cushion 104 in an erect orientation relative to the upper surface 110 of the seat cushion 104 (as seen in the figures) and may also be of the deformably resilient material (the same as the seat cushion 104 and/or seat element 102).

The seat cushion 104 also includes an upper surface 110 configured to support the user, a bottom surface 604 opposing the upper surface 110 of the seat cushion 104, and a seat thickness 200 separating the upper and bottom surfaces 110, 606 of the seat cushion 104 (best seen in FIG. 2). The seat cushion 104 may be approximately 76-152 mm in thickness 200. The seat cushion 104 also includes a rear surface 400 (best seen in FIG. 4) interposed between the upper and bottom surfaces 110, 606 of the seat cushion 104 and a front surface 112 interposed between the upper and bottom surfaces 110, 606 of the seat cushion 104. The rear and front surfaces 400, 112 may be rounded or flat and preferably define the outermost surfaces of the seat cushion 104. The rear and front surfaces 400, 112 may also continuously span the seat cushion 104 from side-to-side of the seat cushion 104. The front surface 112 opposes the rear surface 400 of the seat cushion 104 and defines a cutout channel 700 that spans the seat thickness 200 and that spans rearwardly toward the rear surface 400 of the seat cushion 104.

The seat element 102 is beneficially selectively removably coupled to the seat cushion 104 with at least one fastener or fastening means, preferably a hook-and-loop fastener 708, 710 (shown best in FIG. 7). Other fastening means include one or more magnets, pressure-sensitive adhesive, zipper-track configuration, and other equivalent structures coupled to both the seat cushion 104 and the seat element 102. The seat element 102 is beneficially disposed within the cutout channel 700 for selective removable by the user. The seat element 102 is capable of being completely removed from the seat cushion 104 in a single motion or impetus. Said another way, the seat element 102 is not locked to the seat cushion 104, nor does it require significant force to remove the seat element 102 from the seat cushion 104, e.g., 5-10 lbf (22-44N).

When the seat element 102 is removed, the cutout channel 700 beneficially permits the user insert one or more controls for utilization, e.g., a flight simulation center stick mount. As such, a user is not required to puncture or insert a control through the seat; rather, the user is able to easily and conveniently maneuver the control(s) without being physically obstructed by the detachable seat element 102.

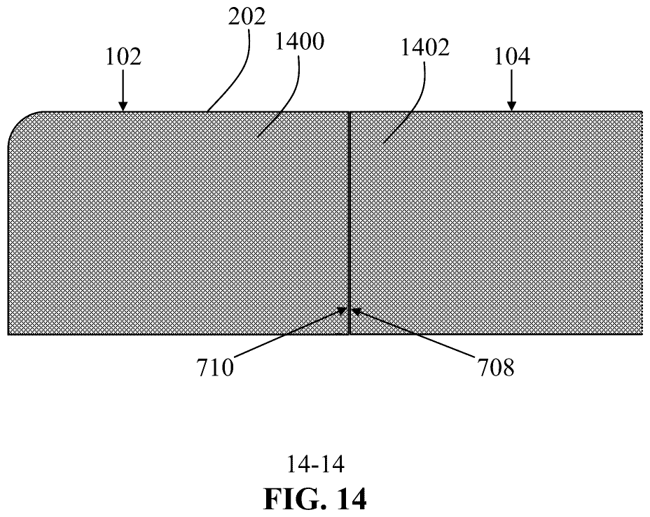

As best seen in FIGS. 7-12, the front surface 112 defining the cutout channel 700 includes two cutout sidewalls 702, 704 opposing one another and may be beneficially formed in a U-shape. A V-shape is also possible, but not as effective. To that end, the front surface 112 defining the cutout channel 700 also includes a rear cutout wall 706 interposed between the two cutout sidewalls 702, 704. The seat element 102 may be selectively removably coupled to the rear cutout wall 706 with a hook-and-loop fastener 708, 710 coupled to both the seat element 102 and the rear cutout wall 706. This can also be seen in the cross-sectional view depicted in FIG. 14. To facilitate in the effective and efficient attachment and detachment of the seat element 102 to the seat cushion 104, the hook-and-loop fastener 708, 710 substantially spans the seat thickness 200. Surfaces on seat cushion 104 and seat element include either the hook or loop fastening portion of the hook-and-loop fastener. In preferred embodiments, only the surface (including the entire rear area defined by the surface) of the seat element 102 that contacts with the rear cutout wall 706 will include the hook-and-loop fastener. The hook-and-loop coupling fastener 708, 710 will also preferably substantially span (at least 80%) and continuously span the seat thickness 200, minimizing the likelihood of the seat element 104 becoming inadvertently dislodged or detached.

To that end, the seat element 102 also substantially spans the seat thickness 20 and is of a shape and a size conforming to a shape and a size of the cutout channel 700. Said another way, the seat element 102 portion disposed in the cutout channel 700 is shaped and sized to snugly fit within cutout channel 700 when inserted therein. Because the seat element 102 is of a deformably resilient material, in some embodiments its sized to be slightly greater (or larger) than the cutout channel 700. To that end, in one embodiment the seat element 102 is selectively removably coupled to the seat cushion 104 using friction or compression against the seat cushion 104 after the seat element 102 is deformed with an external force (e.g., a user squeezing the seat element 102), inserted in the cutout channel 700, and then wherein the external force is released, causing the inherent resiliency of the foam material to securely compress against the walls defining the cutout channel 700. The seat element 102 may also be preferably slightly greater (1-5%) in size than a size of the cutout channel 700 (e.g., having a volume slightly greater than a volume defined by the cutout channel 700).

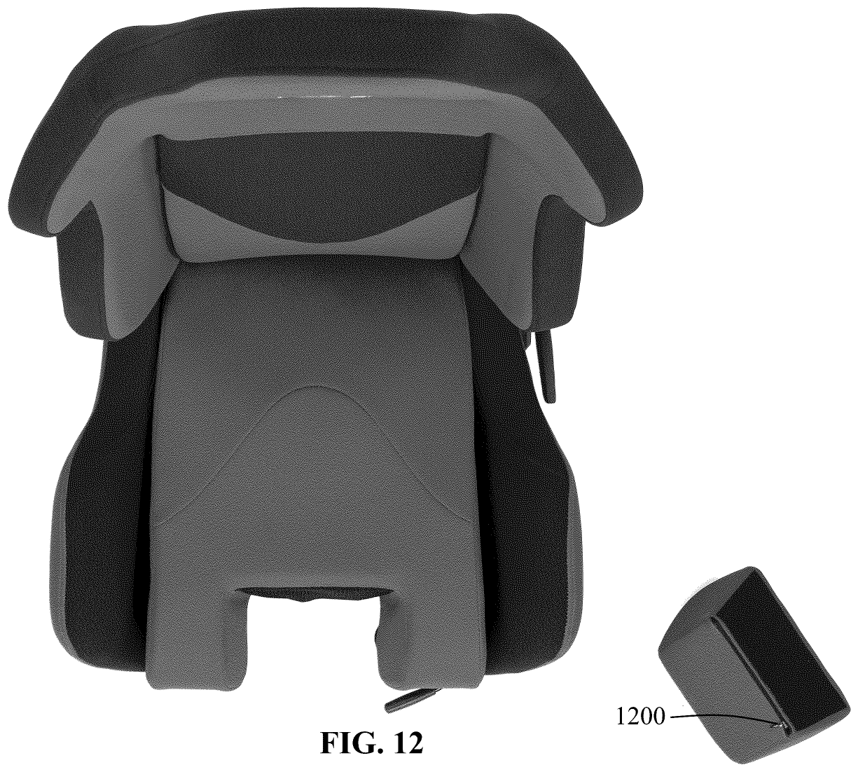

With reference to FIG. 14, the seat element 102 is shown selectively coupled to the seat cushion 104. The seat element 102 can also be seen having a foam seat element body 1400 and a cover 202 encapsulating and/or surrounding the foam seat element body 1400. The cover 202 is operably configured to be selectively opened and closed with at least one fastener 1200, e.g., a zipper (best seen in FIG. 12). The foam seat element body 1400 may also be of a monolithic configuration and formed without any structural frame or support elements (such as metallic support frame elements).

Although a specific order of executing the process steps of utilizing the gaming chair assembly with a detachable seat element, the order of executing the steps may be changed relative to the order shown in certain embodiments. Also, two or more steps described or shown as occurring in succession may be executed concurrently or with partial concurrence in some embodiments. Certain steps may also be omitted for the sake of brevity. In some embodiments, some or all of the process steps can be combined into a single process.

Moreover, various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A racing and flight simulation seat assembly with detachable seat element comprising:
a seat cushion with at least one substantially rigid structural frame element operably configured to couple with a cockpit framework frame assembly, formed with a deformably resilient material, with an upper surface configured to support a user, a bottom surface opposing the upper surface of the seat cushion, a seat thickness separating the upper and bottom surfaces of the seat cushion, with a rear surface interposed between the upper and bottom surfaces of the seat cushion, and with a front surface interposed between the upper and bottom surfaces of the seat cushion, opposing the rear surface of the seat cushion, and defining a cutout channel spanning the seat thickness and spanning rearwardly toward the rear surface of the seat cushion;
a seat element selectively removably coupled to the seat cushion with at least one fastener, formed with a deformably resilient material, and disposed within the cutout channel; and
a back cushion coupled to the seat cushion in an erect orientation relative to the upper surface of the seat cushion.

2. The racing and flight simulation seat assembly with detachable seat element according to claim 1, wherein the seat element, the seat cushion, and back cushion are formed with a foam body.

3. The racing and flight simulation seat assembly with detachable seat element according to claim 1, wherein the front surface defining the cutout channel further comprises:
two cutout sidewalls opposing one another.

4. The racing and flight simulation seat assembly with detachable seat element according to claim 3, wherein the front surface defining the cutout channel further comprises:
a rear cutout wall interposed between the two cutout sidewalls.

5. The racing and flight simulation seat assembly with detachable seat element according to claim 4, wherein the seat element is selectively removably coupled to the rear cutout wall with a hook-and- loop fastener coupled to both the seat element and the rear cutout wall.

6. The racing and flight simulation seat assembly with detachable seat element according to claim 5, wherein the hook-and-loop fastener substantially spans the seat thickness.

7. The racing and flight simulation seat assembly with detachable seat element according to claim 1, wherein the seat element is selectively removably coupled to the seat cushion with a hook-and-loop fastener coupled to both the seat element and the rear cutout wall.

8. The racing and flight simulation seat assembly with detachable seat element according to claim 7, wherein the hook-and-loop coupling fastener substantially spans the seat thickness.

9. The racing and flight simulation seat assembly with detachable seat element according to claim 8, wherein the seat element substantially spans the seat thickness.

10. The racing and flight simulation seat assembly with detachable seat element according to claim 9, wherein the seat element is of a shape and a size conforming to a shape and a size of the cutout channel.

11. The racing and flight simulation seat assembly with detachable seat element according to claim 1, wherein the seat element substantially spans the seat thickness.

12. The racing and flight simulation seat assembly with detachable seat element according to claim 1, wherein the seat element is of a shape and a size conforming to a shape and a size of the cutout channel.

13. The racing and flight simulation seat assembly with detachable seat element according to claim 1, wherein the cutout channel is formed in a U-shape or V-shape.

14. The racing and flight simulation seat assembly with detachable seat element according to claim 1, wherein the seat element further comprises:
a foam seat element body and a cover encapsulating the foam seat element body, the cover operably configured to be selectively opened and closed with at least one fastener.

15. The racing and flight simulation seat assembly with detachable seat element according to claim 14, wherein the foam seat element body is of a monolithic configuration and formed without any structural frame or support elements.

16. The racing and flight simulation seat assembly with detachable seat element according to claim 14, wherein the cutout channel is centrally defined on the seat cushion.

17. An assembly for a racing and flight simulation seat with detachable seat element comprising:
a seat cushion with at least one structural frame element operably configured to couple with a gaming frame cockpit framework assembly, with an upper surface configured to support a user, formed with a deformably resilient material, with a bottom surface opposing the upper surface of the seat cushion, a seat thickness separating the upper and bottom surfaces of the seat cushion, with a rear surface interposed between the upper and bottom surfaces of the seat cushion, and with a front surface interposed between the upper and bottom surfaces of the seat cushion, opposing the rear surface of the seat cushion, and defining a cutout channel centrally defined on the seat cushion, spanning the seat thickness, and spanning rearwardly toward the rear surface of the seat cushion;
a seat element disposed within the cutout channel;
a fastening means configured to selectively removably couple the seat element with the seat cushion; and
a back cushion coupled to the seat cushion in an erect orientation relative to the upper surface of the seat cushion.

18. The racing and flight simulation seat assembly with detachable seat element according to claim 17, wherein the seat element is formed with a deformably resilient material.

19. The racing and flight simulation seat assembly with detachable seat element according to claim 17, wherein the seat element body is formed without any structural frame or support elements.

20. A racing and flight simulation seat assembly with detachable seat element comprising:
a seat cushion with at least one substantially rigid structural frame element operably configured to couple with a cockpit framework frame assembly, formed with a deformably resilient material, with an upper surface configured to support a user, a bottom surface opposing the upper surface of the seat cushion, a seat thickness separating the upper and bottom surfaces of the seat cushion, with a rear surface interposed between the upper and bottom surfaces of the seat cushion, and with a front surface interposed between the upper and bottom surfaces of the seat cushion, opposing the rear surface of the seat cushion, and defining a cutout channel centrally defined on the seat cushion, spanning the seat thickness, and spanning rearwardly toward the rear surface of the seat cushion;
a seat element selectively removably coupled to the seat cushion formed with a deformably resilient material, disposed within the cutout channel, substantially spanning the seat thickness, of a shape conforming to a shape of the cutout channel, of a size slightly greater than a size of the cutout channel, thereby retaining the seat element within the cutout channel; and
a back cushion coupled to the seat cushion in an erect orientation relative to the upper surface of the seat cushion.
